(19) United States
(12) Patent Application Publication
(10) Pub. No.: US 2009/0125674 A1
(43) Pub. Date: May 14, 2009

(54) Method for polymorphic and systemic structuring of associative memory via a third-party manager

(76) Inventor: Michael Vergoz, Sainte Rose (FR)

Correspondence Address: Touret, 4 rue Franck Camille Cadet, Etang Sale, 97427, FR

(21) Appl. No.: 12/319,473

(22) Filed: Jan. 8, 2009

(30) Foreign Application Priority Data
Jun. 12, 2006 (FR) FR06/05225

(51) Int. Cl. G06F 12/00

(52) U.S. Cl. 711/108; 711/E12.001

(57) ABSTRACT

The present invention relates to a method for polymorphic and systemic structuring of associative memory via a third-party manager that allows a human or electronic operator to manage various families of associative memory for various applications.

The present invention relates to an associative memory management unit. The invention allows the management of associative memory to be improved, with an application especially for computers or portable telephones. The particular applications will intervene, for example, in the field of artificial intelligence or in network operations.

### BACKGROUND OF THE INVENTION

Associative memory is a data storage device, in which the search for said data is done directly on the content of the memory and not on the addresses of data stored in the memory. Associative memory may be used in most computer fields. It is used to store very special and valuable data that is henceforth known as the result. Finding this result again will be possible by using a key. Thus, associative memory associates a key to a result. The key is a data chain. The data chain is a sequence of characters. Several computer encoding standards exist that comprise several base characters. According to each computer standard, the characters are coded with a precise corresponding value. The size of the standard is known as the number of possible characters that may be defined in a standard. By way of example, for illustration, the extended ASCII standard is defined over 8 bits, with each character defined by a whole number between 1 and 256. Thus, the size of the ASCII standard is 256. For the ASCII standard, certain characters are readable as characters of the alphabet or numbers; others are not readable as arrow or input instructions. New standards may encode characters over a smaller or larger number of bits.

Clearly, the term associative memory depth is used to describe the size of the data chain corresponding to the number of characters composing this data chain, also known as a key or data chain key. The processing speed of the processor on the associative memory is a function of the depth of the associative memory. When the processor processes the associative memory, it starts with the first character in the data chain. It transcribes the value of the character in one position in a single-columned table and as many lines as the standard size. A table of characters is mentioned. For example, if the value of the character is 12 in extended ASCII, it positions the line cursor on the twelfth line of the 256-line table. The same is true for all the following characters in the data chain. To read the data chain, the processor thus will skip from one table of characters to another table of characters. The size of each table of characters according to the prior art is equal to the size of the standard. The cursor position (P) is made by the memory movements. The 256-line table has a base (B). The character value (C) is used as an integer with relation to this base. Thus (B)+(C)=(P). The succession of cursor positions is known as the route.

Two families of techniques exist from the prior art to manage an associative memory. The first family, known as the limited depth and invariable character table size associative memory family, consists of using a hash algorithm to reduce the depth by various algorithms, such as, for example, MD5 or SHA, which offer a simplified data chain signature. The advantage of this technique is to increase the search performance. A flaw in this technique is that several data chains may have the same signature, which leads to a collision. It is then necessary to have a collision manager. The second family, known as the unlimited depth and invariable character table size associative memory, uses the entire data chain for searching for the result in an associative memory. This family consumes a lot of computer memory but is very precise in its results. With this second family, it is not necessary to have a collision manager.

One main object of the invention is to improve associative memory management by combining the search precision and speed and processing capacity qualities.

One object of the invention is to be able to easily arbitrate between the part taken by the processing capacity and that of the memory consumption.

One object of the invention is to be able to capitalize on the experience in an associative memory, particularly for artificial intelligence.

One object of the invention is to open new uses, such as, for example, application securement by capitalizing on experience.

One object of the invention is to improve authorization and permission management. Permission allocation is finer and more precise. In particular, the invention allows the pagination method to be eliminated.

One object of the invention is to improve the management performance of historical databases, known as, for example, data mining.

One object of the invention is to improve the processing capacity with applications, for example for genetic research, financial or meteorological analysis processing.

One object of the invention is to enable the physical creation of new cards using one or more specific chips particularly associated with static storage, allowing several associative memory management families to be integrated.

One object of the invention is to improve the search for symbols, data or characters within a program.

One object of the invention is to distribute the associative memory over several machines for the management of large quantities of data that may possibly necessitate load balancing.

One object of the invention is to automate flow management by observing traffic and capitalizing on the experience of live traffic. As an illustration, this invention may be used to regulate road traffic by automating traffic light changes. In addition, this object of the invention has the object of providing traffic indications and forecasts.

### BRIEF DESCRIPTION OF THE INVENTION

In one main aspect, the invention proposes a new associative memory management family, known as the systemic and polymorphic structure variable encoding size unlimited depth associative memory family. Systemic structure is understood to refer to a structure containing a large number of interrelated variables. Polymorphic structure is understood to refer to a memory structure that may be modified either by an operator or by a function loaded into this memory structure, this loaded function itself bearing the function of polymorphism.

In one main aspect, the invention allows an operator to restructure the associative memory as needed. The restructurings open new fields of possibilities for associative memory management.

In one aspect, the invention restructures the associative memory, character by character, by assigning a structured memory space capsule to each character that comprises both a pointer and a modified table of characters.

In one aspect, the manager comprises tracing memory management that stores data relating to the passage of the cursor on a character from a character chain in an associative memory. This tracer is polymorphic, that is, it may have a structure with a different type and size, character by character, defined or not by an operator.

In one aspect, the manager comprises a result data management structure. This result management structure is polymorphic, that is, it may have a structure with a different type and size, character by character, defined or not by the operator.

In one particular aspect, the tracer and result data management structures may be used simultaneously and in combination for artificial intelligence applications. In this case, each passage in an element from the table of characters increments the tracer memory. This counting or tracing data is recorded in the tracer memory that subsequently allows a passage rate comparable to an experience capitalization to be deduced. The result is used to store data resulting from processing, whatever the processing. For example, the number of known characters when the data chain is cut if the route has not been entirely found is provided. In the case where the route has not been entirely found, this means that the data chain requested is potentially abnormal. It is the combination of tracing and result data that allows artificial intelligence applications to become a reality. This method may be carried out in physical form; an electronic circuit may be dedicated to these operations.

In one particular aspect, the tracing management structure may be used alone. The use of the tracer alone may allow counts per route or path taken to be done. The use of the tracer alone will enable the number of passages on each possible route to be known.

In one particular aspect, the result management structure may be usable alone. Use of the result structure alone may allow result data to be associated with a key data chain.

In one particular aspect, the invention proposes loading at least 3 associative memory families on a physical chip or a software program, which will be chosen and used according to the needs of the computer program and computer programmer. These three families are the unlimited depth and variable encoding size associative memory, the limited depth and invariable size associative memory and the unlimited depth and invariable size associative memory.

### BRIEF DESCRIPTION OF THE SEVERAL VIEWS OF THE DRAWINGS

The attached figures represent a particular embodiment of the invention in which:

FIG. 1a represents the management of an associative memory according to the prior art, the characters presented in table form

FIG. 1b represents the management of an associative memory according to the prior art, presented schematically in tree form

FIG. 2 represents the structure of the generation of a structured memory space according to the invention

FIG. 3a represents the management of an associative memory according to the manager of the present invention

FIG. 3b represents the management of an associative memory according to the manager of the present invention presented in tree form

FIG. 4 describes a computer expansion card according to one particular aspect of the invention

### DETAILED DESCRIPTION OF THE INVENTION

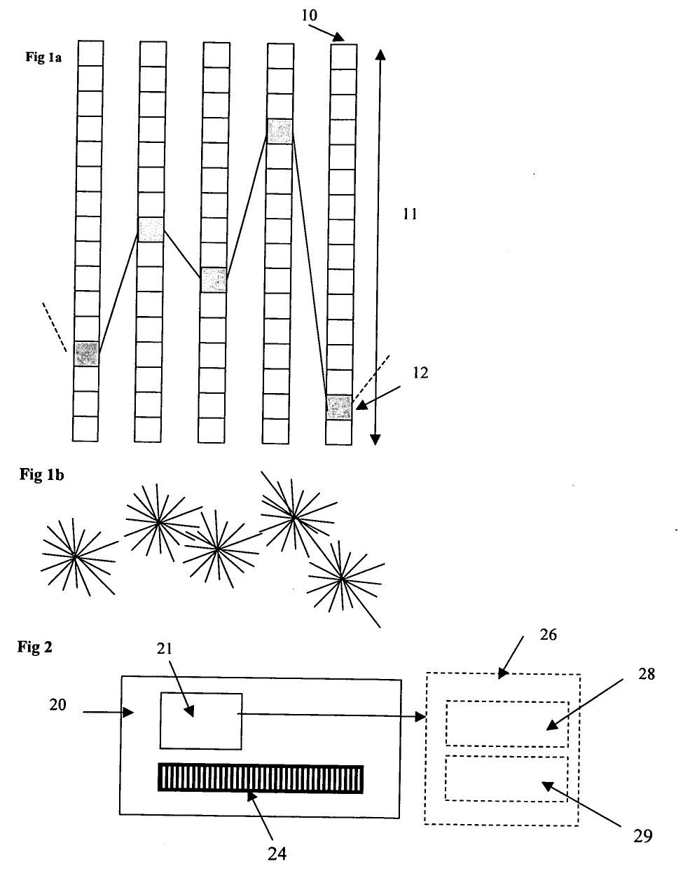

FIG. 1a represents the management of an associative memory according to the prior art, the characters in the form of a table of characters (10), with in the case of FIG. 1a, a standard size (11) that equals sixteen. A fifth table of characters has a character value (12) that equals two, and which thus occupies the second box of the table of characters (10). FIG. 1b represents the management of an associative memory according to the prior art presented schematically in tree form. With this FIG. 1b, it is understood how rapidly the arborescence of choices at every character management multiplies all of the combinations to find the associative memory key, at an exponent (number of characters processed) rate (size of the standard). Usually the set of character processing levels is known as a pipeline in computer language. FIG. 2 represents the structure of the generation of a structured memory space capsule (20) according to the invention. It is constituted of a memory space capsule (20) that comprises a pointer memory space (21) opening on a polymorphic structure (26) composed in the present case of two substructures including a first tracing data substructure (28) and a second result data substructure (29). The first tracing data substructure (28) allows data to be provided on the passageway leading to the result. This data includes, for example, a passage meter. It may also contain more complex functions such as permission allocations, which implies also being able to create permission inheritances by associative memory depth level. These functions are then comparable to the management of permissions in pipeline. The second data substructure may comprise a simple pointer that points to another structure that is a result. It may also contain more complex functions such as the association of a size to a character chain thanks to a substructure composed of a pointer to said character chain (char *ptr) and an integer size (int size). These two data substructures cohabit without particular interaction. However, their property in common is to belong to the same polymorphic structure and the reading of two substructures may be carried out for some comparisons. The structured memory space capsule (20) also comprises a modified table of characters (25). The size of the modified character table (25) is equal to the value of the character (12). This size reduction allows the memory to be optimized. By way of example, the memory space capsule may be made by using a structuring algorithm by a C++ computer code, hereafter:

```
class Poly { };
class Poly_result : public Poly {
    public : void *result ;
} ;
class Poly_trace : public Poly {
    public : void *trace ;
} ;
class Poly_dual : public Poly {
    public: void *result;
    public: void *trace;
};
class Capsule {
    public : void *base ;
    public : int tab_size ;
    public : Poly *pointer;
} ;
```

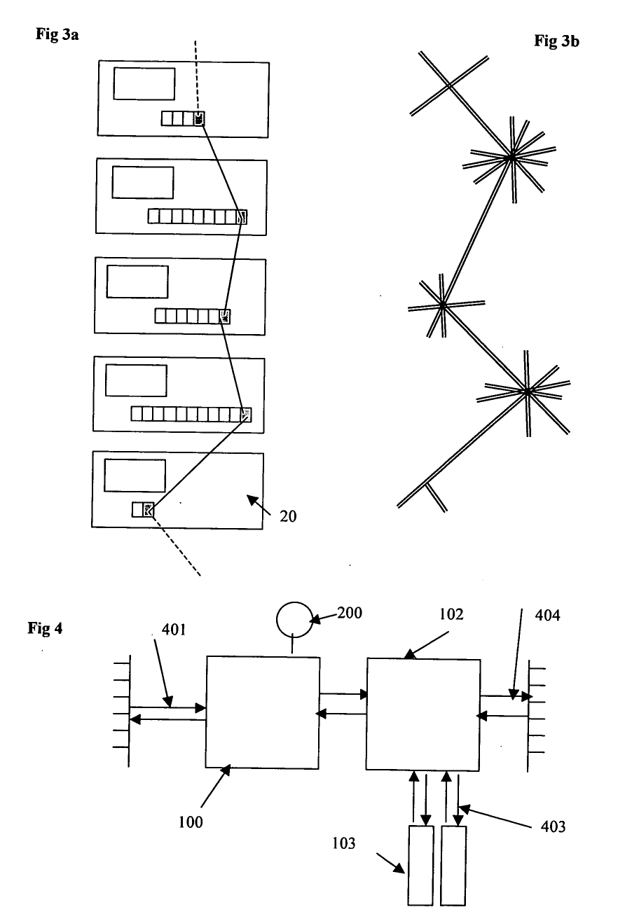

FIG. 3a represents the management of an associative memory according to the invention with a navigation that repeatedly passes from structured memory space capsule (20) to structured memory space capsule (20). Each structured memory space capsule (20) has a specific structure and size, a function in particular of the character (12) from which it results. FIG. 3b represents the management of an associative memory according to the invention presented in tree form. It is immediately visible how the number of possible path combinations is diminished with a total value equal to Π(i=1 à i=n) (12i), (12i) being the value of the the character from the character chain. In addition, data supported when this associative memory is managed is enhanced by new associated data particularly comprising, for example, path and/or result data. FIG. 4 represents a physical implementation electronic diagram on a printed circuit card electrically powered by a battery (200). It comprises an associative memory management processor (102) that allows several associative memory families to be managed. One of these families needs hash mechanisms that the ROM type memory (100) connected by a bus to the associative memory management processor (102) allows to be stored. An optional interface (401) allows this ROM type memory (100) to be reprogrammed. The associative memory management processor (102) will store all data relative to the associative memory in a RAM type memory (103), as for example a SRAM—Static RAM, by means of a bus (403). The number of RAM memory units (103) may be multiple. A bus type interface (404) connected to the associative memory management processor (102) allows any type of circuit, computer or mobile telephone to be interfaced. This interface (404) allows RAM memory data (103) to be accessed through the associative memory management processor (102).

The invention thus relates to an associative memory manager (102), the associative memory being a chain of characters all encoded according to a common standard, at the end of the character chain results are positioned, each character being transcribed by a position corresponding to the value of the character (12) in a table of characters (10) with a single column and a number of lines equal to the size (11) of the standard, the manager reading the character chain, character by character from the start to the end of the character chain, characterized in that the associative memory manager (102) generates for each character a structured memory space capsule (20) that houses at least one pointer memory space (21) opening on a systemic polymorphic structure (26) for managing data relative to the associative memory, and a modified table of characters (24) with a size that is a function of the character value.

The invention thus relates to an associative memory manager characterized in that the data management polymorphic structure is composed of at least one substructure that is either a first tracing data substructure or a second result data substructure, the tracing data being data from the navigation path for reading in the variable size modified characters table.

The invention thus relates to a method for managing associative memory comprising a chain of characters, all encoded according to a common standard, characterized in that the invention comprises, for each character processed successively, at least one step of generating a structured memory space capsule, reservation of memory space in this structured memory space capsule intended to house a pointer, generation of a systemic polymorphic structure extension for the structured memory space capsule accessible by the pointer.

One may see that numerous variations that are possibly likely to be combined may be brought about here without ever departing from the scope of the invention as defined above.

1. An associative memory manager (102), the associative memory being a chain of characters, all encoded according to a common standard, at the end of the character chain results are positioned, each character being transcribed by a position corresponding to the value of the character (12) in a table of characters (10) with a single column and a number of lines equal to the size (11) of the standard, the manager reading the chain of characters, character by character from the start to the end of the character chain, characterized in that the associative memory manager (102) generates for each character a structured memory space capsule (20) that houses at least one pointer memory space (21) opening on a systemic polymorphic structure (26) for managing data relative to the associative memory, and a modified table of characters (24) with a size that is a function of the value of the character.

2. The associative memory manager according to claim 1 characterized in that the polymorphic structure for managing data is composed of at least one substructure that is either a first tracing data substructure or a second result data substructure, the tracing data being data from the reading navigation path in the modified variable size character table.

3. A method for managing an associative memory comprising a chain of characters, all encoded according to a common standard, characterized in that the method comprises, for each successively processed character, at least
one step for generating a structured memory space capsule
one memory space reservation in this structured memory space intended to house a pointer
one generation of a systemic polymorphic extension structure for the structured memory space capsule accessible by the pointer.
